(19) United States
(12) Patent Application Publication
(10) Pub. No.: US 2015/0025812 A1
(43) Pub. Date: Jan. 22, 2015

(54) METHOD AND APPARATUS FOR DISCOVERY, DEVELOPMENT AND CLINICAL APPLICATION OF MULTIPLEX ASSAYS BASED ON PATTERNS OF CELLULAR RESPONSE

(71) Applicant: Norman A. Paradis, Putney, VT (US)

(72) Inventor: Norman A. Paradis, Putney, VT (US)

(21) Appl. No.: 14/508,582

(22) Filed: Oct. 7, 2014

Related U.S. Application Data
(63) Continuation-in-part of application No. 13/360,433, filed on Jan. 27, 2012.
(60) Provisional application No. 61/436,911, filed on Jan. 27, 2011.

(51) Int. Cl. G06F 19/00

(52) U.S. Cl. CPC G06F 19/345; G06F 19/3431
USPC 702/19

(57) ABSTRACT

A method for the discovery, development and clinical application of multidimensional multiplex synthetic biomarker assays based on patterns of cellular response.

After stimulation or inhibition, a selected multiplicity of cell types are assayed for a multiplicity of cellular or molecular responses, and known machine learning techniques are used to synthesize the cellular responses into an optimized clinical biomarker. The computationally derived algorithm includes the relationships within and between the component steps so as to produce an optimized synthetic clinical biomarker. During discover of the assay one or more of the component steps are repeated iteratively until a final clinically optimized algorithm is produced.

Such a multidimensional multiplex cell response assay may provide improved diagnostic performance with respect to entities such as immune status, infection, and antibiotic and vaccine efficacy, among others.

### REFERENCE TO PENDING PRIOR PATENT APPLICATION

The present patent application is a Continuation-In-Part of pending prior U.S. application Ser. No. 13/360,433 filed on Jan. 27, 2012, which claims priority to Provisional Patent Application Ser. No. 61/436,911, filed Jan. 27, 2011 by Norman A. Paradis for MULTIPLEX METHOD FOR DISCOVERY AND CLINICAL APPLICATION OF CELL FUNCTION-BASED BIOMARKER PATTERNS (Attorney's Docket No. BARASH-1 PROV), which patent application is hereby incorporated herein by reference.

### FIELD OF THE INVENTION

The invention disclosed here relates in general to the field of medical diagnostics, and more specifically methods for noninvasively diagnosing or predicting the risk of medical conditions.

### SUMMARY OF THE INVENTION

In accordance with the present invention, there is a provided method and apparatus for the discovery, development and clinical application of multiplex synthetic biomarker assays based on patterns of cellular response. After stimulation and or inhibition, selected cell types are assayed for cellular or molecular responses, lack of responses, or changes in state. These are combined into an optimized clinical biomarker using known mathematical or machine learning techniques.

A method for the discovery, development and clinical application of multidimensional multiplex synthetic biomarker assays based on patterns of cellular response. After stimulation or inhibition, selected cell types are assayed for cellular or molecular responses. These are combined into an optimized clinical biomarker using known machine learning techniques.

Specifically, a method for discovery, development and optimization of an assay diagnostic of, or predictive of the risk of, a disease, the method comprising:

obtaining specimens that have been characterized with respect to the disease of interest using existing diagnostic techniques;

separating and characterizing constituent cell populations from within the samples;

adding a multiplicity of stimulatory, inhibitory, or other biologically active agents to each of the cell types;

measuring a multiplicity of cellular and molecular responses;

computationally deriving an algorithm that optimizes the logical relationships within and between the component steps so as to produce an optimized synthetic clinical biomarker; and

repeating one or more of the foregoing steps iteratively so as to further optimize the clinical performance of the algorithm.

Such a multidimensional multiplex cell response assay may provide improved diagnostic performance with respect to entities such as immune status, infection, antibiotic and vaccine efficacy.

Assays based on the functional response of cells may be multiparametrically optimized at each step in the process, that is in multiple dimensions. These may include, but are not limited to, (1) the stimulants or inhibitors, (2) the target cell populations, and (3) the cellular responses. Such biomarkers may sometimes hereinafter be referred to as multidimensional multiplex cell response assays (M2CRA).

Because cellular responses are central to homeostasis and disease in metazoans, this technology has broad applications, including but not limited to, (1) as an engine for discovery of multiplex clinical assays based on cellular responses, (2) as multiplex in-vitro clinical assays, (3) research instruments for elucidation of biologic function, and (4) as companion diagnostics for pharmaceuticals.

### BACKGROUND OF THE INVENTION

Biomarkers that provide clinically useful results when measured in a univariate manner are uncommon. For this reason, much current genomic, proteomic and gene expression research is directed toward discovery of multivariate patterns that are identified computationally and synthetically multiplexed.

To date, the vast majority of clinically used in-vitro diagnostic assays are proteomic, and are based on measurement of molecular concentration. Investigators have tried to improve and broaden the utility of molecular concentration data through computationally multiplexing the measured concentrations of multiple analytes. Gene and gene expression data have been subjected to similar techniques, with only limited clinical success.

Widely used cellular assays remain uniplex and rudimentary. Most simply count the number of cells present, or use traditional methods to characterize cell type, as with the classical complete blood count. Significant innovation has been the characterization of cell types based on cell surface patterns of receptors. Of particular importance to the current disclosure, the vast majority of cellular diagnostics utilize only the number of each cell type and not its function or responsiveness, and those that measure cellular function or response do so only in a uniplex manner.

An example of such characterization is CD4 (cluster of differentiation 4), a glycoprotein expressed on the surface of T helper cells, monocytes, macrophages, and dendritic cells. Patients with HIV are managed using the CD4 cell counts, but not the functional status of the CD4 cells themselves.

Although there are diagnostic assays that utilize cellular response, they do not synthesize the functional responses of multiple cell types. The Elispot assay, for instance, attempts to characterize clinical status by visual measurement of the cellular production of a single molecular species. It has not been standardized or FDA cleared, and it has not been multiplexed. Flow cytometry simply counts or sorts the types of cells present by cell surface receptors, and suffers from similar limitations.

The crude state of cell-based assays may explain their relatively limited use clinically. More sophisticated assays of greater diagnostic accuracy, especially those related to immune cell function, would have significant potential in oncology, rheumatology, infectious disease, and transplantation, among others. Of particular potential might be so-called “companion diagnostic” assays for monoclonal antibodies directed at lymphocytes.

### DETAILED DESCRIPTION OF THE PREFERRED EMBODIMENTS

In accordance with the present invention, there is a provided method and apparatus for the discovery, development and clinical application of multiplex synthetic biomarker assays based on patterns of the cellular response. After stimulation and or inhibition, selected cell types are assayed for cellular or molecular responses, lack of responses, or changes in state. These are combined into an optimized clinical biomarker system using known mathematical or machine learning techniques. The multi-parametric optimization may include stimulants or inhibitors, cell types, cellular responses, and multidimensionally between these steps.

### Method for Developing the Multidimensional Multiplex Cell Response Assays (M2CRA)

In one preferred form of the present invention, the discrete steps in the discovery, development, and application of multidimensional multiplex cell response assays (M2CRA) may include:
1. Obtaining whole blood specimens that have been phenotyped for the disease of interest. Such phenotyping may be done on the basis of clinical diagnostics, patient outcomes or the use of established “gold standard” tests.
2. Stimulation or inhibition, or a combination of both, of cells in whole blood or subfractions of blood. The list of stimulants and inhibitors may include: mitogens, cytokines, chemokines, peptides, glycoproteins, bacterial products, growth factors, phorbyl esters, and cells, among others. More than one stimulant may be used, or a combination of stimulants and inhibitors may be used.
3. Isolation or separation of cell types—the list of cell populations may include any type of cell for which a separation mechanism is available. Isolation of cell types may be accomplished using an automated cell separator, e.g., the Miltenyi Biotec AutoMACS Separator or the Stemcell Technologies RoboSep machine. Cell populations may be purified based on positive or negative selection strategies using antibodies bound to magnetic microbeads, or other separation methods may be used. An additional refinement of the method may allow for measurement of cellular responses without separation.
4. Multiplex measurement of cellular responses in each of the cell types. Examples of measurable cellular responses may include, but are not limited to, metabolic products such as ATP, RNA expression, high-throughput proteomics, gene expression, metabolomics, proteomics or secreted products, among others.
5. Under some conditions, the steps of stimulation and separation may be may be reversed, such that cell separation precedes cell stimulation. Purified cell populations may then be stimulated with appropriate agents, followed by detection of measurable cellular responses.
6. Computational discovery and optimization of a multidimensional multiplex cell response assay (M2CRA) using supervised or unsupervised learning. In supervised learning, gold standard tests may be utilized by machine learning systems as the “classifying variable” during the training phase of algorithm development. The artificial intelligence system may also optimize the algorithm between each of the optimized functional categories.
7. As a multidimensional multiplex clinical assay, the invention may be automated to a variable degree. At one end of this range, it may be left in a form similar to the discovery engine, with each discreet step run by technicians. Progressive automation may include interfacing the components with systems such as the Tecan robotics sample processor all the way through “lab on a chip” technology. The regulatory path may be RUO through IVD.

Multiplex cell response assay (M2CRA) systems comprise four major components, which are optimized according to the specific assay under development:
1. Cell Mixture
2. Stimulant-Suppressant
3. Multiplex Response
4. Mathematical Conversion to an optimized actionable clinical biomarker

It is understood that the order of these steps may be changed or combined.

At the discovery phase, multiplex cell response assay (M2CRA) systems may have an additional specimen phenotyping or gold standard. It should also be noted that in the discovery and development of individual assays, the constituents of each major component may be optimized using high-throughput techniques, appropriate clinical classifiers and machine learning algorithms.

### (1) Cell Mixture

A mixture of immune cells (i.e., T-Cell, B-Cell, Macrophage, among others) and various trophic factors, optimized for the particular assay, may be provided. Various technologies may be used to adjust and optimize the mixture, including, but not limited to, cell sorters, flow cytometry, magnetic beads with monoclonal antibodies, and others.

Cells included in the Cell Mixture may include:
1. Peripheral blood mononuclear cells (PBMC)
2. T-Cell in particular T-Helper, Cytotoxic (CD-8) and others
3. B-Cell
4. Neutrophils
5. Macrophage
6. Dendritic Cell
7. Stem Cell
8. Natural Killer Cell
9. Antigen Presenting Cell

The source of the above cells may be varied, including intravascular, mucosal, and CSF (cerebrospinal fluid) among others. Isolates from tumors or pathologically-affected organs may also be used.

### 2) Stimulant-Suppressant

A mixture of stimulants and suppressants, also optimized for a particular assay, is then added or co-cultured.

Examples may include:
1. Antigens
2. Mitogens
3. Lymphokines
4. Molecules from bacterial, viral, or fungal sources
5. Endogenous autoimmune related molecules
6. Polyclonal stimuli
7. Growth factors
8. Colony stimulating factors
9. Synthetic peptides or other macromolecules
10. Inhibiting monoclonal antibodies
11. Fluorophores
12. Phorbolmyristate acetate (PMA)
13. Ionomycin
14. Monensin
15. Brefeldin A
16. Sodium chromate for measurement of chromium release
17. Diethylenetriaminepentaacetic acid
18. Adjuvants, such as ISCOMS and Incomplete Freund's Adjuvant (IFA)

The concentrations of any of the above stimulants/suppressants may be varied. The constituents of the cell culture media may be varied. There can also be variation in the incubation period.

Initial components that may be evaluated experimentally for inclusion in either the Cell Mixture or Stimulant-Suppressant Mixture may be chosen empirically, based on a current understanding of the pathophysiology of the disease in question. A large number of components may be evaluated experimentally for inclusion in the Multiplex Response pattern because of the availability of high-throughput techniques.

### 3) Multiplex Response

The multiplex cellular response pattern is then measured. This pattern of response may be made up of measurement of:
1. Antibodies
2. Lymphokines
3. Chemokines
4. Intracellular protein staining
5. Interleukins such as IL-2, IL-4, IL-6, IL-12
6. Interferons such as IFN-γ
7. Cell surface markers: CD 25, CD 69, CD 71, HLA-DR
8. Components of cell signaling cascades
9. Patterns of gene expression
10. RNA by PCR
11. Enzyme-linked immunospot (ELISPOT)
12. Patterns of RNA inhibition
13. Fluorometry
14. Cell signaling pathways
15. Measurement of compliment
16. Indicators of B or T cell activation
17. Indicators of Stem cell activation
18. Indicators of NK cell activation
19. Indicators of cell-tissue mobilization—integrins
20. Indicators of apoptosis or necrosis
21. Indicators of hematopoiesis
22. fluorescence staining
23. Quantification using limiting dilution assays
24. Colorimetric measurement
25. TNF-α
26. Indicators of MHC-peptide binding such as the tetramer assay
27. Any of the above compared to a control
28. Indicator substances for any of the above
29. Kinetic patterns for any of the above
30. Concentration patterns for any of the above
31. Concentration and kinetic patterns combined for any of the above

The response patterns can be measured in a number of different manners:
1. Lymphoproliferation—measured by any of a number of mechanisms including radiolabelled thymidine
2. ELISA and similar assays
3. High-throughput genomics and proteomics
4. Mass spectroscopy

4) Mathematical Conversion to an actionable clinical biomarker (an assay): Techniques for development of multiplex algorithms are well known (see, for example, Kato K. Algorithm for in vitro diagnostic multivariate index assay. Breast Cancer 2009; 16(4):248-251), and include multivariate analysis and neural networks along with supervised techniques such as, among others:

Analytical learning

Artificial neural network

Backpropagation

Boosting (meta-algorithm)

Bayesian statistics

Case-based reasoning

Decision tree learning

Inductive logic programming

Gaussian process regression

Group method of data handling

Kernel estimators

Learning Automata

Minimum message length (decision trees, decision graphs, etc.)

Multilinear subspace learning

Naive Bayes classifier

Nearest Neighbor Algorithm

Probably approximately correct learning (PAC) learning

Ripple down rules, a knowledge acquisition methodology

Symbolic machine learning algorithms

Subsymbolic machine learning algorithms

Support vector machines

Random Forests

Ensembles of Classifiers

Ordinal classification

Data Pre-processing

Handling imbalanced datasets

Statistical relational learning

Proaftn, a multicriteria classification algorithm

During the discovery phase of the multiplex cell response assay (M2CRA), it is anticipated that more than one of these techniques will be evaluated for its ability to derive the best and most efficient clinical biomarker. The model that produces the optimal diagnostic performance is selected using a clinical classifier such as a diagnostic gold standard. The multi-parametric optimization may include stimulants or inhibitors, cell types, cellular responses, and multidimensionally between these steps. In particular, the objective is to identify the most accurate diagnostic algorithm based on the fewest number of input variables. Once the multiplex algorithm is developed, it is preferably converted to an index for ease of clinical use.

A good exemplar for the computational component of the invention might be multi-layer multi category neural networks in which the stimulant/inhibitor, cellular and response portions are handled by different layers, and the multidimensional optimization is handled by activation and perception.

Once taught the invention, a practitioner of ordinary skill in the art, would know that the essential components of invention include: identification of the clinical problem to be addressed, choice of cells, choice of stimulants/inhibitors, choice of response measurements, choice of machine learning, need for iterative application of these steps. For each of these steps, a practitioner of ordinary skill in the art will be familiar with the complete range of possible choices.

A practitioner of ordinary skill in the art will know to optimize the algorithm iteratively using additional clinical data sets, clinical classifiers, along with patient characteristics and laboratory derived measurements as needed.

As is known to a practitioner of ordinary skill in the art, the choice of cells, choice of stimulants/inhibitors, choice of response measurements, may be undertaken empirically based on current knowledge of the systems biology of the problem of interest, but also that high-throughput and robotics technologies allow first-pass development to include a large number of cells and molecules. (Arndt-Jovin and Jovin 527-58)

Once that algorithm has been discovered, developed and optimized, a practitioner of ordinary skill in the art may finalize the assay by transforming the output results of the algorithm to a uniplex numerical or visual scale or index that is a probabilistic biomarker indicative of the risk or presence of the disease.

As known by practitioners skilled in the art, the probability of deriving clinically useful algorithms using the techniques of machine learning is enhanced if the number of input variables is increased and they are independent measures of pathophysiologically distinct information.

The in silico techniques used to create models and algorithms are well known to those familiar with the art. The numerous specific techniques may be categorized as supervised, unsupervised, reinforcement, and association rule learning, statistical classification, partition and hierarchical clustering, and deep learning techniques, among others. Among the most commonly used are the various forms of regression, including multiple linear and logistic regressions.

Particularly important to the present disclosure is the widely acknowledged phenomena that the performance of machine learning derived algorithms is to a great extent independent of the specific in silico technique used for its derivation. This is emphasized by the packaging of numerous techniques on software packages, which may run some or all of them simultaneously on data sets.

Some of the machine learning techniques require a classifier. In development of clinical biomarkers the classifier is exemplified by separation of the training data set between patients with or without the disease of interest based on the use of a “gold standard” diagnostic test. Examples of gold standard tests would include the use of cardiac echocardiography in the diagnosis of congestive heart failure or troponin in diagnosis of acute myocardial infraction.

Within the context of the present invention, multiplexing is intended to mean a multivariable optimization of elements within each of the component steps: stimulants and inhibitors, cells, and molecular responses. Multidimensional is intended to mean a multivariable optimization of the elements and relationships within and between the components steps. The higher-order optimization means that the selected components of each step are optimized within the context of the others steps and the final selection may be different from the circumstances in which a step is optimized individually.

A large number of existing machine learning methods are potentially applicable to multidimensional multiplexing so as to derive an algorithm that optimizes the logical relationships within and between the component steps with the intention to produce an optimized synthetic clinical biomarker. Neural networks provide a particularly good exemplar. Each component step of the method—stimulants and inhibitors, cells, and molecular responses—can be addressed by layers of hidden or perceptron interneurons.

Practitioners of ordinary skill in the art will understand that modern high-speed computers make it unnecessary to select an ideal machine learning method. Data mining software packages can run each of many potential methods so as to identify the technique with the best performance. Best performance can be the area under the curve for receiver operator characteristic curve for the gold standard classifier, or the desired sensitivity and specificity can be prespecified.

A practitioner of ordinary skill in the art will know that, an input parameter may be used to modify the pre-test probability distribution of other inputs of the mathematical model, or even the final multiplex algorithm.

A practitioner of ordinary skill in the art will know that that the machine learning may be further optimized by inclusion of patient, clinical, hospital or epidemiology data as inputs to the machine learning process. A particular embodiment would be adaptation of the algorithm based on the results of proteomic, genomic or other in vitro diagnostic measurements.

A practitioner of ordinary skill in the art will also appreciate that the synthetic biomarker may be adaptive, improving over time or as a function of feedback within a specific epidemiologically useful unit. For example, the biomarker algorithm may be different in hospitals whose incidence of the disease in question are different. Some of these inputs may be adaptable at the bedside, as for instance, the patient's age or sex. Some or all of the input parameters may also be obtained internally from the patient via tomography or imaging.

A practitioner of ordinary skill in the art will understand that the computational component of the present invention may be implemented using a computational device, e.g., an appropriately programmed general purpose computer, a dedicated computer, etc., with the output of the computational device being displayed to the user.

Additionally, a practitioner of ordinary skill in the art will know that the key portions of the multidimensional multiplex cell response assay (M2CRA) may be implemented using various

### Particular Embodiments of Multidimensional Multiplex Cell Response Assays

Patients with acute or chronic infection—is the patient infected? Is there going to be an effective clinical response? In this situation, the Cell Mixture may include cell types known to be functional in the immune response to the disease in question. The Stimulant-Suppressant Mixture may include a combination of bacterial, viral or fungal antigens/epitopes specific to the disease or potential diseases in question. The measured Multiplex Response may include cytokines, lymphokines or interferons related to infection with, or immunity to, the disease in question.

Assay for TB exposure, immunity or current active disease. In this situation, the Cell mixture may include cell types known to be functional in the immune response to the tubercle bacillus such as cytotoxic cells. The Stimulant-Suppressant Mixture may include a combination of tubercle bacillus antigens or even whole bacillus such as BCG. The measured multiplex response may include cytokines in dictated of immunity or infection such as gamma interferon or IL-12.

Viral Infection, Reactivation or Immune Status. In this situation, the Cell Mixture may include cell types known to be functional in the immune response to the virus in question such as T-Helper and Cytotoxic-T cells. The Stimulant-Suppressant Mixture may include a combination of viral subtypes, epitopes, or even whole virus. The measured multiplex response may include cytokines indicative of immunity, reactivation or infection such as gamma interferon or IL-12, or peptide-loaded MHC complexes. In addition to the examples described above, the M2CRA may be developed for any viral illness.

Fungal Infection, Reactivation or Immune Status. Delineating the clinical status of patients potentially infected with fungal species such as Candida, histoplasmosis, aspergillosis, and others is particularly challenging for clinicians. These may be dormant or active depending on the immune status of the patient. In this situation, the Cell Mixture may include cell types known to be functional in the immune response to fungal pathogens such as macrophages, T-Cells, and neutrophils. The Stimulant-Suppressant Mixture may include a combination of fungal epitopes, or even whole fungus. Also included may be ligands for receptors that initiate innate immunity. The measured Multiplex Response may include cytokines indicative of immunity, reactivation or infection such as gamma interferon or IL-12.

Cytomegalovirus (CMV), Infection, Reactivation or Immune Status. In this situation, the Cell Mixture may include cell types known to be functional in the immune response to CMV such as T-Helper and Cytotoxic-T cells. The Stimulant-Suppressant Mixture may include a combination of CMV epitopes, CMV pp65 and IF-1 proteins, or even whole virus. The measured Multiplex Response may include cytokines indicative of immunity, reactivation or infection such as gamma interferon or IL-12, or peptide-loaded MHC complexes.

Herpes Simplex Virus (HSV) Infection, Reactivation or Immune Status. In this situation, the Cell Mixture may include cell types known to be functional in the immune response to HSV such as T-Helper and Cytotoxic-T cells. Stimulant-Suppressant Mixture may include a combination of HSV subtypes, epitopes, or even whole virus. The measured Multiplex Response may include cytokines indicative of immunity, reactivation or infection such as gamma interferon or IL-12, or peptide-loaded MHC complexes.

HIV Infection, Reactivation or Immune Status. In this situation, the Cell Mixture may include cell types known to be functional in the immune response to HIV such as T-Helper and Cytotoxic-T cells. The Stimulant-Suppressant Mixture may include a combination of HIV subtypes, epitopes, or even whole virus. The measured Multiplex Response may include cytokines indicative of immunity, reactivation or infection such as gamma interferon or IL-12, or peptide-loaded MHC complexes.

Vaccine Response. CMI is central to the efficacy of vaccines. In developing a M2CRA for vaccine response measurement, the Cell Mixture may include cell types known to be functional in the immune response induced by the vaccine, such as T-Helper and Cytotoxic-T cells. Stimulant-Suppressant Mixture may include a combination of epitopes that constitute the vaccine. The measured Multiplex Response may include indicators of immune cell response.

Cancer and Cancer Vaccines Assays. Host CMI is likely important to the outcome in patients with cancer, and is the basis of efficacy of cancer vaccines. In developing a M2CRA for vaccine response measurement, the Cell Mixture may include cell types known to be functional in the immune response to cancer in question such as dendritic cells, CD-8, T-Helper, Cytotoxic-T cells or NKC. The Stimulant-Suppressant Mixture may include a combination of antigens derived from oncogenes, overexpressed genes, embryonic genes, normal differentiation genes, viral genes (HPV), tumor-suppressor genes (p53), and other tumor-associated proteins (MUC1). Tumor-derived RNA, apoptotic bodies, and lysates may also be used. The measured Multiplex Response may include cytokines indicative of immunity, reactivation or infection such as gamma interferon or IL-12, or peptide-loaded MHC complexes.

Neurological Diseases such as Multiple Sclerosis, Alzheimer's and others. Many neurological diseases, such as MS, have CMI as an intrinsic component of their pathophysiology. In developing a M2CRA for a neurological disease, the Cell Mixture may include cell types known to be involved in the disease process itself and these may best be obtained from cerebrospinal fluid. The Stimulant-Suppressant Mixture may include a combination of proteins also known to be involved in the disease. In the case of MS, this may be myelin basic protein or a subset of its epitopes. The measured Multiplex Response may include indicators of immune cell response.

Allergy Tests. Delineating the clinical status of patients potentially suffering with allergic illness is also particularly challenging for clinicians. The range of illness includes mucosal inflammation, dermatitis, anaphylaxis, etc., and cannot be confused with illnesses of other etiology. M2CRAs might be particularly useful in the evaluation of allergic patients. In this situation, the Cell Mixture may include cell types known to be important in allergy such as Ig-E producing B Cells, but also including macrophages, T-Cells. Stimulant-Suppressant Mixture may include a combination of potentially allergic epitopes. The measured Multiplex Response may include Ig-E, histamine, complement, among others.

These examples are intended to augment the description of some possible M2CRA. It is understood that the system is a generalizable platform that will likely allow development of clinical diagnostic assays in almost any area of medicine.

### DESCRIPTION OF THE RELATED ART

Machine learning derived multiplex algorithms constructed from the measurement of multiple individual serum molecular concentrations have been widely studied as innovative in vitro diagnostics. (Kato 248-51) These same approaches, however, have not been applied in systemic disease to non-molecular measurements such as those based on electromagnetic or optical sensing.

As in molecular multivariate assays, it is widely appreciated that useful mathematical diagnostic algorithms may be developed using the in silico techniques variously called machine learning, data mining, and big data, among other terms. For the purposes of the present disclosure, the term “machine learning” will be used to represent all possible mathematical in silico techniques for creation of useful algorithms from large data sets. The term “algorithm” will be utilized in reference to the clinically useful mathematical equations or computer programs produced by the process disclosed. Particularly important to the present disclosure is the widely acknowledged phenomena that the performance of machine learning derived algorithms is independent of the specific in silico software routine used for its derivation. If the same training data set is used, techniques as different as supervised learning, unsupervised learning, association rule learning, hierarchical clustering, multiple linear and logistic regressions are likely to produce algorithms whose clinical performance is indistinguishable.

Although the techniques of machine learning are to a great extent interchangeable, it is well known to those skilled in the art that the independence of the individual variables used in the model is of great importance. Multiple variables will bring no additional diagnostic performance if they are highly correlated and essentially measure the same tissue parameter. With respect to the present invention, it is anticipated that the utilization of anatomic and temporal patterns of organ systems that are physiologically distinct in their response to impending shock will enhance the performance of the algorithm.

Any diagnostic method initially developed to diagnose disease may also be used to guide therapy. With respect to the present invention, the algorithm may also be optimized as an adjunct to resuscitation and treatment of shock. As such, it would function as a goal for directing therapy. Such targeted therapeutics are often called theranostics.

These and other objects, features and advantages of the present invention will become clearer when the drawings as well as the detailed description are taken into consideration.

Limitations in the Prior Art: There is no prior art teaching cell function assays incorporating a combination of:

1. multiple stimulants or inhibitors

2. multiple target cell populations

3. multiple cellular responses

Additionally, no prior art teaches assay optimization via multi-parametric machine learning involving one or more of the above steps. As such, the prior art would not include application of the multi-parametric machine learning to the algorithmic relationships between steps. Phrased differently, the prior art does not teach multiplexing of cell function assays, much less multidimensional multiplexing as defined herein.

The following comprehensive searches of the World Wide Web find no results:
No results found for “multivariate cell function assay”
No results found for “multiplex cell function assay”
Search for “multiplex cell response assay” reports only our patent application
No results found for “computer generated cell function assay”.
No results found for “computer generated cell response assay”.
Search for “combination of stimulants and inhibitors” and “cell response assay” reports only our patent application
No results found for IVDMIA “multivariate cell function assay”.
No results found for IVDMIA “multiplex cell function assay”.
No results found for “multidimensional machine learning”
No results found for “multilayer machine learning”
Search for “multilayer machine learning” and “cell” found 7 results, none in the life sciences
Search for “multilayer machine learning” and “cellular” found 4 results, none in the life sciences

Similar searches in Pubmed resulted in no citations within the life sciences.

It is possible to read multiplexing incorrectly into the prior art. This confusion and error stems principally from the insertion of patent legalese, such as “of at least” or “one or more”, into phrases that were intended to be singular. An example of this phenomenon is the ungrammatical phrase “comparing the level of said at least one biomarker . . . ” in Claim 1 in Aukerman 2008 (US 027-4118 A1). Careful and correct reading of such prior art demonstrates no prospective intent to utilize modern multi-parametric methods. The appearance of multiplexing is likely the result of an attorney editing the singular to the plural throughout the document as is their want.

### Modifications

It will be understood that many changes in the details, materials, steps and arrangements of elements, which have been herein described and illustrated in order to explain the nature of the invention, may be made by those skilled in the art without departing from the scope of the present invention.

Since many modifications, variations and changes in detail can be made to the described invention, it is intended that all matters in the foregoing description be interpreted as illustrative and not in a limiting sense.

Now that the invention has been described,

### OTHER PUBLICATIONS INCORPORATED IN THE CURRENT APPLICATION BY REFERENCE

### Reference List

Arndt-Jovin, D. J. and T. M. Jovin. “Automated cell sorting with flow systems.” Annu. Rev. Biophys. Bioeng. 7 (1978): 527-58.

Kato, K. “Algorithm for in vitro diagnostic multivariate index assay.” Breast Cancer 16.4 (2009): 248-51.

Cohn, J. N. “Blood pressure measurement in shock. Mechanism of inaccuracy in ausculatory and palpatory methods.” JAMA 199.13 (1967): 118-22.

Jobsis, F. F. “Noninvasive, infrared monitoring of cerebral and myocardial oxygen sufficiency and circulatory parameters.” Science 198.4323 (1977): 1264-67.

Kato, K. “Algorithm for in vitro diagnostic multivariate index assay.” Breast Cancer 16.4 (2009): 248-51.

Lewis, S. B., et al. “Cerebral oxygenation monitoring by near-infrared spectroscopy is not clinically useful in patients with severe closed-head injury: a comparison with jugular venous bulb oximetry.” Crit Care Med. 24.8 (1996): 1334-38.

Soller, B. R., et al. “Noninvasively determined muscle oxygen saturation is an early indicator of central hypovolemia in humans.” J. Appl. Physiol (1985.) 104.2 (2008): 475-81.

What is claimed is:

1. A method for determining the current or future probability of a disease, comprising:
obtaining a multiplicity of cells the distribution of which has previously been optimized with respect to the other component steps of the method and the diagnostic purpose of interest;
adding a multiplicity of stimulatory, inhibitory, or other biologically active agents, the distribution of which has previously been optimized with respect to the other component steps of the method and the diagnostic purpose of interest;
measuring a multiplicity of molecular cell responses the distribution of which has previously been optimized with respect to the other component steps of the method and diagnostic purpose of interest; and
applying a computational algorithm or equation, previously optimized for the diagnostic purpose, to the molecular responses, so as to produce a mathematical result diagnostic of, or predictive of the risk of, a disease.

2. A method for discovery, development and optimization of an assay diagnostic of, or predictive of the risk of, a disease, the method comprising:
obtaining specimens that have been characterized with respect to the disease of interest using existing diagnostic techniques;
separating and characterizing constituent cell populations from within the samples;
adding a multiplicity of stimulatory, inhibitory, or other biologically active agents to each of the cell types;
measuring a multiplicity of cellular and molecular responses;
computationally deriving an algorithm that optimizes the logical relationships within and between the component steps so as to produce an optimized synthetic clinical biomarker; and
repeating one or more of the foregoing steps iteratively so as to further optimize the clinical performance of the algorithm.

3. A method according to claim 1 or 2 wherein the mathematical result is transformed to a simplified index indicative of the diagnostic likelihood, or future risk, of the disease of interest.

4. A method according to claim 1 or 2 wherein the order of the component steps is changed so as to further improve performance.

5. A method according to claim 1 or 2 wherein more than one classifier, each weighted differently, are used to derive the algorithm.

6. A method according to claim 1 or 2 wherein at least one of the cell types is obtained after administration of physical or pharmacologic agents whose physiologic effects on the probability distribution is favorable diagnostic performance.

7. A method according to claim 1 or 2 wherein the at least one specimen is whole blood or a subfraction such as serum or plasma.

8. A method according to claim 1 or 2 wherein the at least one cell type is involved in an immune response, such as peripheral blood mononuclear cells (PBMC), T-Helper, Cytotoxic (CD-8) cell, Neutrophil, Dendritic Cell, Stem Cell, Natural Killer Cell, Antigen Presenting Cell.

9. A method according to claim 1 or 2 wherein at least one stimulatory or inhibitory agents is a cytokine, chemokine, or immunological epitope of interest.

10. A method according to claim 1 or 2 wherein the at least one stimulatory or inhibitory agent is selected from the group consisting of: an antigen, a mitogen, a lymphokine, molecules from bacterial, viral, or fungal sources, endogenous autoimmune related molecules, a growth factor, a colony stimulating factor, synthetic peptides or other macromolecules, inhibiting antibodies, phorbolmyristate acetate (PMA), Ionomycin, Monensin, brefeldin A, diethylenetriaminepentaacetic acid, or an adjuvant such as ISCOMS or incomplete Freund's Adjuvant.

11. A method according to claim 1 or 2 wherein the cell types are separated before the adding of stimulatory or inhibitory agent, and the reactions are performed in individual reaction chambers.

12. A method according to claim 1 or 2 wherein at least one component of the measured cellular response is the identification of the presence of a macromolecule, such as a protein, lipid, nucleic acid, or metabolite.

13. A method according to claim 1 or 2 wherein the measured cellular response is the concentration of two or more substances selected from the group consisting of: lymphokines; chemokines; interleukins, interferons, cell surface markers, components of cell signaling cascades; ribonucleic acid, compliment, indicators of B or T cell activation, indicators of stem cell activation, indicators of NK cell activation, indicators of cell-tissue mobilization—integrins, indicators of apoptosis or necrosis, indicators of hematopoiesis, indicators of MHC-peptide binding, or patterns of gene expression.

14. A method according to claim 1 or 2 wherein the cellular response is measured using one or more of: intracellular protein staining, RNA by PCR, Enzyme-linked immunospot (ELISPOT), Fluorometry, fluorescence staining, quantification using limiting dilution assays, colorimetric measurement, indicator substances, kinetic patterns, concentration patterns, lymphoproliferation, radiolabelling, ELISA and similar assays, high-throughput genomics and proteomics, mass spectroscopy.

15. A method according to claim 1 or 2 wherein the stimulatory or inhibitory agents comprise a combination of bacterial, viral or fungal antigens/epitopes and the assay is intended to characterize patients with respect to acute or chronic infection or immunity to infection.

16. A method according to claim 1 or 2 wherein the assay is intended to identify patients with acute or chronic infection through stimulation with appropriate epitopes from the organism of interest.

17. A method according to claim 1 or 2 wherein the assay is intended to determine if a cancer has developed, progressed, regressed, gone into remission or been cured after treatment.

18. A method according to claim 1 or 2 wherein the assay is intended to determine if a patient is at risk of, or is developing, a neurological disease such as multiple sclerosis, Alzheimer's, Parkinson's, or others.

19. A method according to claim 1 or 2 wherein the assay is intended to determine if a patient is allergic to a specific allergen, to degree of allergy, or the response to treatment of an allergy.
